(19) United States
(12) Patent Application Publication
(10) Pub. No.: US 2025/0180370 A1
(43) Pub. Date: Jun. 5, 2025

(54) INFORMATION PROCESSING DEVICE

(71) Applicant: TOYOTA JIDOSHA KABUSHIKI KAISHA, Toyota-shi (JP)

(72) Inventors: Kazuya OKADA, Tokyo (JP); Hiroshi ABE, Kasukabe-shi (JP); Naoya KANEKO, Tokyo (JP); Toru FURUSAWA, Yokohama-shi (JP); Takayuki SAKAI, Tokyo (JP); Koji TAKEOKA, Yokohama-shi (JP)

(73) Assignee: TOYOTA JIDOSHA KABUSHIKI KAISHA, Toyota-shi (JP)

(21) Appl. No.: 18/790,242

(22) Filed: Jul. 31, 2024

(30) Foreign Application Priority Data
Dec. 1, 2023 (JP) 2023-204039

(51) Int. Cl. G01C 21/36; H04W 4/46; H04W 72/542

(52) U.S. Cl. CPC G01C 21/3697; H04W 4/46; H04W 72/542

(57) ABSTRACT

A control unit configured to: acquire a quality map regarding a planned traveling route of the first vehicle and quality of wireless communication for each area; and send data used by the first vehicle in the first area to the first vehicle before the first vehicle reaches the first area in response to the planned traveling route passing through the first area where the quality of wireless communication is lower than a predetermined quality.

### CROSS-REFERENCE TO RELATED APPLICATION

This application claims priority to Japanese Patent Application No. 2023-204039 filed on Dec. 1, 2023, incorporated herein by reference in its entirety.

### BACKGROUND

### 1. Technical Field

The present disclosure relates to information processing devices.

### 2. Description of Related Art

Efficient streaming control based on current network quality is known in the art (e.g., Japanese Unexamined Patent Application Publication No. 2013-081158 (JP 2013-081158 A)).

### SUMMARY

An object of the present disclosure is to suitably download data.

One aspect of the present disclosure is an information processing device including a control unit. The control unit is configured to acquire a quality map regarding quality of wireless communication for each planned travel route and area of a first vehicle, and when the planned travel route passes through a first area where the quality of the wireless communication is lower than predetermined quality, send data that the first vehicle uses in the first area to the first vehicle before the first vehicle reaches the first area.

Other aspects of the present disclosure include an information processing method in which a computer executes processes in the information processing device, a program that causes the computer to execute the information processing method, and a storage medium storing the program in a non-transitory manner.

According to the present disclosure, it is possible to suitably download data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a system according to an embodiment;

FIG. 2 is a diagram illustrating a table configuration of a vehicle-information DB;

FIG. 3 is a diagram illustrating an example of a quality map;

FIG. 4 is a diagram illustrating an exemplary travel route of vehicles; and

FIG. 5 is a flowchart illustrating a process of sending data from the center server to the vehicle according to the first embodiment.

### DETAILED DESCRIPTION OF EMBODIMENTS

When a vehicle moves to an area where high-speed and large-capacity communication cannot be performed due to difficulty in receiving radio waves in mountainous areas or tunnels when using a streaming service, the streaming service is delayed or interrupted. Therefore, it is conceivable to download all data in advance, but when the use of the streaming service is stopped in the middle, unnecessary communication costs are incurred.

Therefore, in the present disclosure, data to be used in the first area is sent to the vehicle in advance in a case where the vehicle is expected to pass through an area where the communication quality is deteriorated on the basis of the planned traveling route of the vehicle using the streaming service and the map relating to the communication quality. Therefore, the control unit acquires a quality map related to the planned traveling route of the first vehicle and the quality of the wireless communication for each area. The first vehicle is a vehicle on which a user using the streaming service is riding. The planned traveling route of the first vehicle may be, for example, a route set in the car navigation system, or may be a route predicted based on the traveling route up to the current point of time and the past route history. A AI may be used to predict this. The area may be, for example, an area defined by an administrative section or an area mesh, or may be an arbitrarily defined area. The quality of the wireless communication may be determined based on the data transfer rate of the downlink. The data transfer rate may be included in the probe data collected from the plurality of second vehicles. The quality map is a map generated so that at least an area in which the communication quality satisfies the required quality can be distinguished from an area in which the communication quality does not satisfy the required quality. This map may be generated by the control unit. The map may be stored in the storage unit in advance.

In addition, in response to the planned traveling route passing through the first area where the quality of the wireless communication is lower than the predetermined quality, the control unit sends data used by the first vehicle in the first area to the first vehicle before the first vehicle reaches the first area. Here, the predetermined quality may be a quality required for the streaming service, or may be a quality that enables wireless communication. The first area is an area in which it is difficult to use the streaming service because the quality of the wireless communication is lower than a predetermined quality. In addition, the first area may be an area in which a state in which the data transfer rate of the downlink is lower than the required quality continues for a predetermined time or longer. When a vehicle passes through such a first area, the streaming service is stopped. Therefore, the control unit sends data used by the first vehicle in the first area to the first vehicle before the first vehicle reaches the first area. For example, the time when the first vehicle enters the first area and the time when the first vehicle leaves the first area may be estimated, the data used for the time when the first vehicle travels in the first area may be identified, and the identified data may be sent to the first vehicle. The data used when the first vehicle travels in the first area may be specified based on, for example, a playlist of music to be played. As another example, in response to the first vehicle traveling in the first area, for example, all data to be used thereafter may be sent to the first vehicle. Note that sending the data to the first vehicle includes sending the data directly from the information processing device to the first vehicle. And sending a command to download the data to the first vehicle, wherein the first vehicle downloads the data from the information processing device or an external server. In this way, when the first vehicle passes through an area where the quality of the wireless communication becomes lower than the predetermined quality, the data sent by the control unit in advance can be used in the first vehicle. Therefore, the streaming service can be continuously used.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

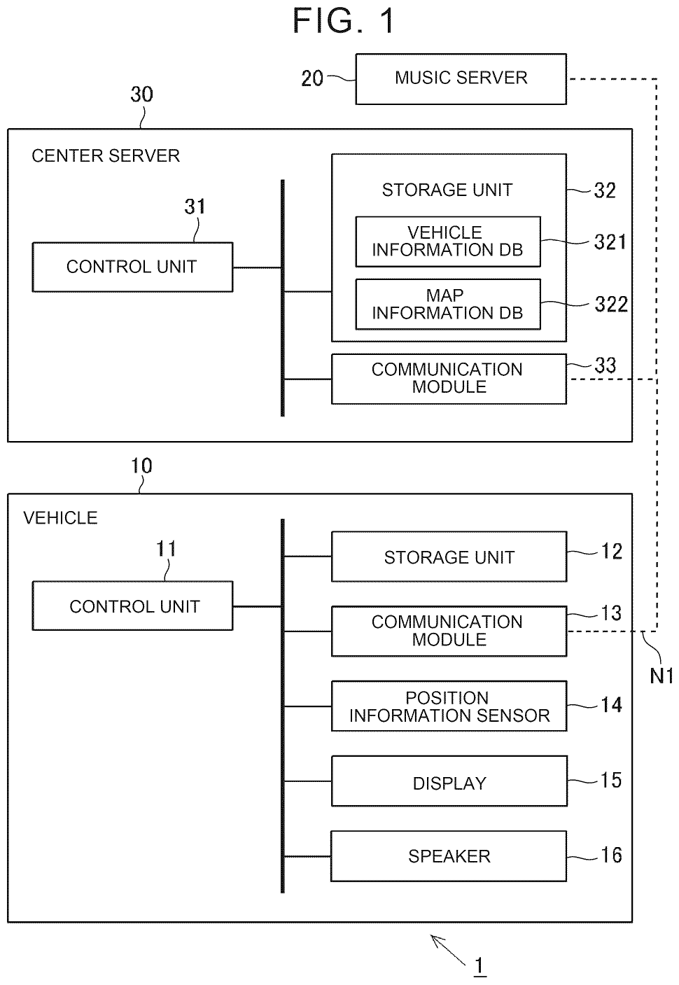

FIG. 1 is a schematic diagram of a system 1 according to an embodiment. In the example of FIG. 1, the system 1 includes a vehicle 10, a music server 20, and a center server 30. There may be a plurality of vehicles 10. The center server 30 may include a plurality of servers. The vehicles 10, the music server 20, and the center server 30 are connected to each other by a network N1. The network N1 is, for example, a world-wide public communication network such as the Internet, and a wide area network (WAN) or other communication networks may be adopted. In addition, the network N1 may include a telephone communication network such as a mobile phone network and a wireless communication network such as Wi-Fi (registered trademark).

The vehicle 10 is a connected car that periodically sends information (probe data) such as a location, a communication line, and communication quality to the center server 30. These pieces of information sent from the vehicle 10 to the center server 30 are also referred to as vehicle information below. The vehicular information may include information on communication quality such as RSRP (Reference Signal Received Power), RSRQ (Reference Signal Received Quality), or SINR (Signal-to-Interference-plus-Noise Ratio). In addition, the vehicle information may include information on whether or not the downlink and uplink are connected, and a data transfer rate of the downlink and uplink. Further, the vehicle information may further include information about each of the measurement position of the data transfer rate and the measurement date and time of the data transfer rate.

The music server 20 is, for example, a server that provides music for a fee or free of charge via the Internet. The music server 20 is managed by, for example, a content provider. The music data provided from the music server 20 can be streamed and reproduced in the vehicle 10. In addition, the music data can be downloaded and stored in the vehicle 10. The user may perform user registration in advance for the music server 20.

The center server 30 sends data (music data) used in the area to the vehicle 10 before the vehicle 10 travels in the area where the communication quality is low. The center server 30 includes a control unit 31, a storage unit 32, and a communication module 33. The music server 20 has the same configuration as that of the center server 30.

The center server 30 can be configured as a computer including a processor (such as a CPU, GPU), a main storage device (such as a RAM, ROM), and a secondary storage device (such as an EPROM, a hard disk drive, and a removable medium). The secondary storage device stores an operating system (OS), various programs, various tables, and the like. By executing the program stored therein, it is possible to realize each function (software module) that meets a predetermined purpose, as will be described later. However, some or all of the modules may be realized as hardware modules by, for example, hardware circuitry such as a ASIC, FPGA.

The control unit 31 is an arithmetic unit that realizes various functions of the center server 30 by executing a predetermined program. The control unit 31 can be realized by, for example, a hardware processor such as a CPU. The control unit 31 may include a RAM, ROM, a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB 321 and map information DB322) is constructed in the storage unit 32. The vehicle information DB 321 stores information collected from the vehicles 10.

The map information DB322 stores map data including a feature position, and map information including information POI (Point of interest) of characters, photographs, and the like indicating properties of respective points on the map data). Note that the map-information DB322 may be provided from another system connected to the network N1, for example, a GIS (Geographic Information System).

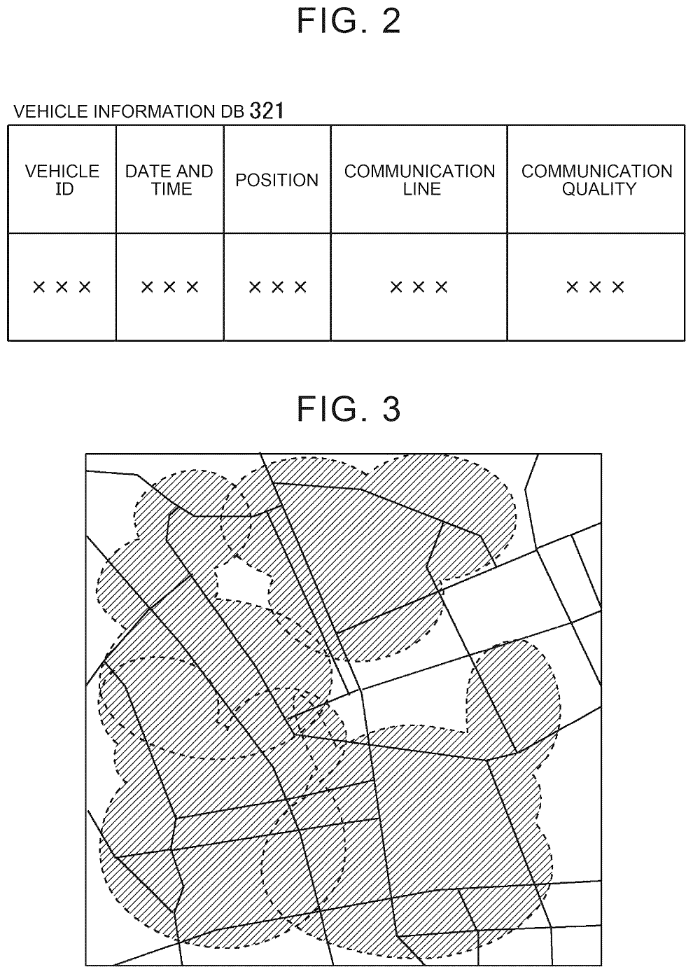

FIG. 2 is a diagram illustrating a table configuration of the vehicle information DB 321. The vehicle information DB 321 stores date and time information, position information, communication line information, and communication quality information in association with the vehicle ID. These pieces of information are collectively called vehicle information. The vehicle ID is identification information unique to the vehicle 10. The date and time information are information on the date and time when the communication quality is measured. The position information is information related to a position at which the communication quality is measured, and is, for example, information indicated by latitude and longitude. The communication line information is information related to a communication line used in the vehicle 10. The communication line information may be, for example, information related to a communication method such as 4G, 5G, Wi-Fi (registered trademark). The communication quality information may be information on RSRP (Reference Signal Received Power) and RSRQ (Reference Signal Received Quality). The communication-quality information may be information about SINR (Signal-to-Interference-plus-Noise Ratio). In addition, the communication quality information may include information on continuity (connected or disconnected) of communication. In addition, the communication quality information may include at least information on a data transfer rate of the downlink. The vehicle information is periodically sent from the vehicle 10. The control unit 31 stores the received vehicle information in the vehicle information DB 321.

The communication module 33 is a communication interface for connecting the center server 30 to the network N1. The communication module 33 may be configured to include, for example, a network interface board, a wireless communication interface for wireless communication, and the like. The center server 30 can perform data communication with the vehicle 10 via the communication module 33.

Note that the specific hardware configuration of the center server 30 can be omitted, replaced, or added as appropriate depending on the embodiment.

Next, the vehicle 10 will be described. The vehicle 10 includes a control unit 11, a storage unit 12, a communication module 13, a position information sensor 14, a display 15, and a speaker 16. These configurations may be realized by a combination of DCM (Data Communication Module), a head unit, an in-vehicle device such as a car navigation system, and the like. The control unit 11 is an arithmetic unit that realizes various functions of the vehicle 10 by executing a predetermined program. The control unit 11 can be realized by, for example, a hardware processor such as a CPU. In addition, the control unit 11 may be configured to include a RAM, ROM (Read Only Memory), a cache memory, and the like.

The storage unit 12 is a unit that stores information, and is configured by a storage medium such as a RAM, a magnetic disk, or a flash memory. The storage unit 12 stores a program executed by the control unit 11, data used by the program, and the like. In addition, the storage unit 12 can store music data. The storage unit 12 is used as a buffer in the streaming service.

The communication module 13 is a communication unit for connecting the vehicles 10 to the network N1. In the present embodiment, the vehicles 10 can communicate with other devices (for example, the music server 20 and the center server 30) over a network N1 using a mobile communication service such as a 3G, LTE, 5G, 6G. The communication module 13 is an example of a wireless device. The position information sensor 14 acquires position information (for example, latitude and longitude) of the vehicle 10 at a predetermined cycle. The position information sensor 14 is, for example, a GPS (Global Positioning System) receiver, a wireless communication unit, or the like. The display 15 is a device for presenting data to a user, such as a LCD (Liquid Crystal Display) or an EL (Electroluminescence) panel. Note that the display 15 may be configured as a touch panel display. The speaker 16 is a device that outputs sound. The sounds include music.

The control unit 11 of the vehicle 10 collects vehicle information at predetermined time intervals and sends the collected vehicle information to the center server 30. In addition, the control unit 11 of the vehicle 10 is configured to be able to use a streaming service (for example, a music distribution service). For example, the control unit 11 of the vehicle 10 can receive the music data using the music distribution service provided by the music server 20 and output the music via the speaker 16. In addition, the control unit 11 of the vehicle 10 sends information related to the streaming service being used to the center server 30. The information about the streaming service includes information about the music being played, information about a playlist indicating the order of music to be played, and the like.

The control unit 11 of the vehicle 10 sends the travel route of the vehicle 10 to the center server 30. For example, when the travel route is guided in the car navigation system, the guided travel route and destination are sent to the center server 30.

Next, the control unit 31 of the center server 30 will be described in detail. The control unit 31 of the center server 30 generates a quality map related to the quality of the wireless communication based on the vehicle information collected from the plurality of vehicles 10. The quality map may be generated for each area and for each time. The “every hour” may be classified into a day of the week, a weekday and a holiday, a time zone (daytime, nighttime, midnight, and the like), and the like.

FIG. 3 is a diagram illustrating an example of a quality map. FIG. 3 is a diagram illustrating an area in which the quality of wireless communication is equal to or higher than a predetermined quality on a map. In FIG. 3, an area in which the quality of wireless communication is equal to or higher than a predetermined quality is surrounded by a broken line. As a result, a boundary between an area where the communication quality is equal to or higher than the predetermined quality and an area where the communication quality is lower than the predetermined quality is defined by a broken line. In FIG. 3, the hatched area is an area where the communication quality is equal to or higher than the predetermined quality. The area other than the hatched area is an area where the communication quality is less than the predetermined quality, and is hereinafter also referred to as the first area. The predetermined quality in the communication quality may be set such that at least one of Reference Signal Received Power RSRP, Reference Signal Received Quality RSRQ, and Signal-to-Interference-plus-Noise Ratio SINR is equal to or greater than the required value. The predetermined quality may be a fixed value. In addition, the quality map may be, for example, a map that separates an area in which a state in which the data transfer rate of the downlink is lower than the predetermined quality continues for a predetermined time or longer and an area in which the data transfer rate is not the predetermined quality. The predetermined time period may be a time period in which a trouble occurs in providing the streaming service. For example, in a time required for the vehicle 10 to pass through the first area (hereinafter, also referred to as a passing time), music can be prevented from being interrupted by using a buffer in some cases. For example, if “buffer size+past data transfer rate×transit time” is larger than “required data transfer rate×transit time”, it is possible to prevent music from being interrupted. Here, the past data transfer rate is a data transfer rate acquired by vehicle information. The passing time is the time required to pass through the first area, and can be calculated by dividing the distance traveled by the vehicle 10 in the first area by the speed of the vehicle 10. As the speed of the vehicle 10, a legal speed on the road or an average speed of a plurality of vehicles 10 traveling on the same road in the past can be used. The required data transfer rate is a data transfer rate that can prevent music from being interrupted. Note that the quality map may correspond to at least the downlink. The quality map may be generated in advance and stored in the storage unit 32, or may be generated every time a travel route is acquired from the vehicle 10.

In addition, the control unit 31 determines whether or not the traveling route passes through the first area on the quality map in response to the acquisition of the information on the traveling route of the vehicle 10 while the streaming service is being used in the vehicle 10. The travel route at this time may be, for example, a route being guided by the car navigation system, or a route predicted by using AI from the current location and the previous travel history. In response to determining that the traveling route passes through the first area on the quality map, the control unit 31 generates data that can use the streaming service being used in the vehicle 10 offline, and sends the data to the vehicle 10. At this time, a command for reproducing music in accordance with the data sent to the vehicle 10 may be sent to the vehicle 10.

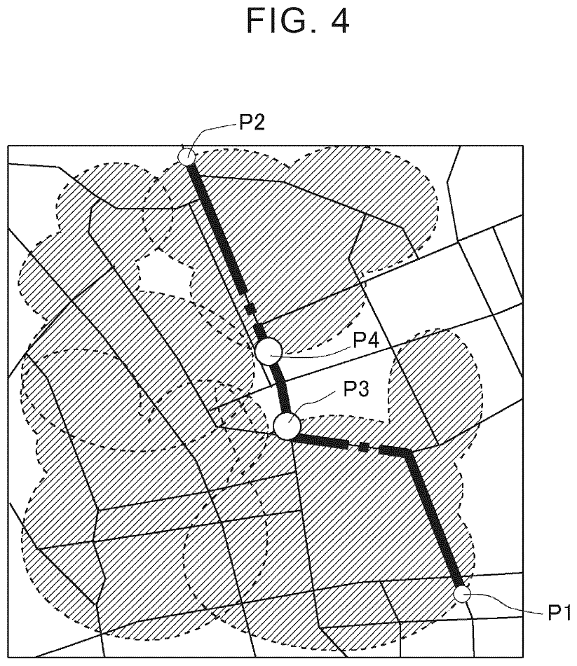

FIG. 4 is a diagram illustrating an example of a travel route of the vehicle 10. The first route indicated by a dashed-dotted line indicates, for example, a travel route guided in the navigation system. In FIG. 4, the vehicle 10 moves from the point indicated by P1 to the point indicated by P2. The first route is generated by the control unit 11 of the vehicle 10 on the basis of, for example, the position of P1 which is the current location, the position of P2 which is the destination, and the map information stored in the map information DB322. The first route is generated so as to be a route according to a predetermined rule such as a route in which the travel distance of the vehicle 10 is shortest, a route in which the travel time of the vehicle 10 is shortest, and the like. The first route may be generated by the control unit 11 of the vehicle 10 or may be generated by the control unit 31 of the center server 30.

In the first route, the communication quality is less than the predetermined quality in a section from the point indicated by P3 on the traveling route to the point indicated by P4. Therefore, there is a possibility that the streaming service cannot be received while the vehicle 10 is traveling during this period. Therefore, the control unit 31 downloads, from the music server 20, data that can use the streaming service currently being used in the vehicle 10 offline. Then, the data is sent to the vehicle 10. As another example, the control unit 31 of the center server 30 sends a command for downloading music data from the music server 20 to the vehicle 10.

At this time, the control unit 31 causes the vehicle 10 to download data corresponding to the time when the communication is interrupted in advance. For example, the music played when passing through the first area may be estimated, and only the music data may be downloaded. As another example, for example, a portion of music played when passing through the first area may be estimated, and only data corresponding to the portion may be downloaded. That is, instead of downloading all the data of one song, for example, only a necessary portion may be downloaded in units of chunks.

The control unit 31 estimates a time at which the vehicle 10 enters the first area (hereinafter, also referred to as entry time) and a time at which the vehicle 10 exits the first area (hereinafter, also referred to as exit time) in a case where the vehicle 10 travels on the first route. In the following description, the entry time and the exit time are together also referred to as passing times. The transit time is calculated by the navigation system of the vehicle 10. For example, the control unit 11 of the vehicle 10 may calculate a time at which each point on the first route passes, and send the time to the center server 30 together with the first route. The control unit 31 of the center server 30 obtains the intersection point between the first route and the boundary line of the first area as the passing time of the vehicle 10.

Further, the control unit 31 estimates data required when the vehicle 10 passes through the first area. For example, the control unit 31 estimates the position of the song being reproduced when the vehicle 10 passes through the first area. The position of the song can be expressed, for example, as the elapsed time from the beginning of the song. The inference of the position of the song includes the inference of the song title and the inference of the elapsed time from the beginning of the song. At this time, the control unit 31 acquires, for example, a playlist from the vehicle 10, and assumes that the songs are played in the order of the playlists, and acquires the positions of the songs being played at the entry time and the positions of the songs being reproduced at the exit time. The control unit 31 stores in the vehicle 10 the music data corresponding from the position of the song to be played at the entry time to the position of the song to be played at the time when the vehicle 10 exits the first area. Note that the song played at the entry time and the song played at the exit time may be different songs. In addition, a plurality of songs may be played from the entry time to the exit time.

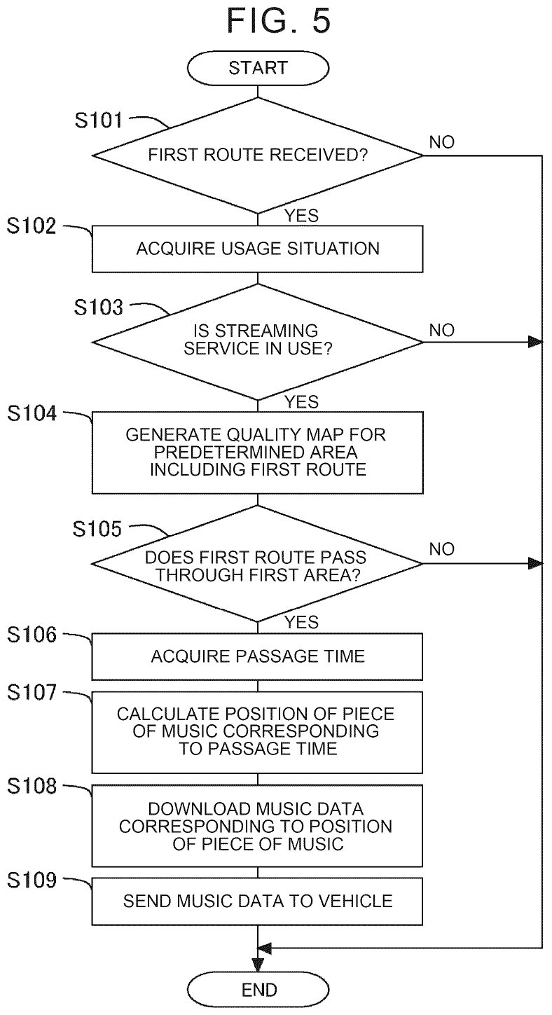

FIG. 5 is a flowchart illustrating a process of sending data from the center server 30 to the vehicle 10 according to the first embodiment. The flowchart illustrated in FIG. 5 is executed at predetermined time intervals in the center server 30. It is to be noted that the vehicle information DB 321 and the map information DB322 will be described on the assumption that the required information is already stored.

In S101, the control unit 31 determines whether or not the first route has been received from the vehicles 10. For example, when the user inputs a destination in the car navigation system, the control unit 11 of the vehicle 10 searches for a travel route from the current location to the destination. When the travel route is determined, the control unit 11 of the vehicle 10 sends the first route to the center server 30. The information on the first route may be sent from the vehicle 10 to the center server 30 together with the vehicle information. If the control unit 31 makes an affirmative determination in S101, the process proceeds to S102, and if a negative determination is made, the routine ends.

In S102, the control unit 31 acquires the usage status of the streaming service. This streaming service is a service currently in use. At this time, information (for example, a playlist) indicating a song to be played back in the future may be acquired. The control unit 31 acquires whether or not, for example, music is being streamed and reproduced in the vehicle 10. For example, the control unit 11 of the vehicle 10 may send, to the center server 30, information that can determine that music is being streamed and reproduced in the vehicle 10, and information related to the playlist, together with information related to the first route.

In S103, the control unit 31 determines whether or not the streaming service is being used. If the control unit 31 makes an affirmative determination in S103, the process proceeds to S104, and if a negative determination is made, the routine ends.

In S104, the control unit 31 generates a quality map of a predetermined area including the first route. The predetermined area is an area where the vehicle 10 may pass when going to a destination. For example, the control unit 31 may generate a quality map of an area within a predetermined distance from the first route. Note that the control unit 31 may generate a quality map and store it in the storage unit 32 in advance. Then, in S104, the control unit 31 may refer to the quality map of the predetermined area including the first route from the storage unit 32.

The quality map may be generated by the control unit 31 in accordance with the current date and time. For example, a quality map may be generated based on vehicle information collected on the same day of the week. Further, if the present is a weekday, a quality map may be generated based on the vehicle information collected on the weekday, and if the present is a holiday, a quality map may be generated based on the vehicle information collected on the holiday. Further, the quality map may be generated based on the vehicle information collected in the same time zone as the current time zone. This time period may be divided by, for example, daytime, nighttime, midnight, or the like, or may be divided every hour, for example.

In S105, the control unit 31 determines whether or not the first route passes through the first area. If the control unit 31 makes an affirmative determination in S105, the process proceeds to S106, and if a negative determination is made, the routine ends.

In S106, the control unit 31 acquires the transit time. The transit time is provided from the vehicle 10 together with the first route, for example. As another example, the control unit 31 may calculate the passing time based on the first route. For example, assuming that the speed of the vehicle 10 is the legal speed on the road or the average speed of the plurality of vehicles 10 that have traveled the same road in the past, the control unit 31 calculates the passing time. When the vehicle 10 passes through the first area a plurality of times, the control unit 31 calculates passage times corresponding to the respective areas.

In S107, the control unit 31 calculates the position of the song corresponding to the calculated passing time. The control unit 31 calculates the position of the song corresponding to each of the entry time and the exit time based on the playlist. In addition, the control unit 31 extracts all of the pieces of music when it is estimated that a plurality of pieces of music are reproduced between the entry time and the exit time on the basis of the playlist.

In S108, the control unit 31 downloads music data corresponding to the position of the song calculated in S107. That is, music data required from the entry time to the exit time is downloaded from the music server 20. Note that, for a piece of music that is presumed to be playing at the entry time, only the piece of music data corresponding to the part of the piece of music that is later than the entry time may be downloaded, or the piece of music data corresponding to all of the pieces of music may be downloaded. In addition, for a song that is presumed to be playing at the exit time, only music data corresponding to the portion of the previous song from the exit time may be downloaded, or music data corresponding to all of the songs may be downloaded. In addition, in a case where a different song is included in the playlist between the song being played at the entry time and the song being played at the exit time, all pieces of music data of the song are downloaded. In this way, all pieces of music data required from the entry time to the exit time are downloaded.

In S109, the control unit 31 sends the music data downloaded in S108 to the vehicles 10. At this time, the information sent by the control unit 31 to the vehicle 10 may include a command for reproducing the downloaded music data for the time from the entry time to the exit time. The control unit 31 completes the process in this S109 prior to the vehicles 10 reaching the first area.

As described above, according to the present embodiment, when it is predicted that the vehicle 10 will pass through the first area where it is difficult to receive the streaming service, data required in advance can be stored in the vehicle 10. Thus, for example, interruption of music can be suppressed. The music data stored in the vehicle 10 can be minimized.

In the above description, the center server 30 downloads the music data and sends it to the vehicle 10, but as another example, the center server 30 may send a command to download the music data to the vehicle 10. Then, the control unit 11 of the vehicle 10 that has received the command may download the music data. Here, in S108, the control unit 31 generates a command to download the music data instead of downloading the music data. Then, in S109, the control unit 31 sends a command for downloading the music data to the vehicle 10 instead of sending the music data to the vehicle 10. In accordance with this command, the control unit 11 of the vehicle 10 downloads the music data. Even in this manner, the data used by the vehicle 10 in the first area can be sent to the vehicle 10 before the vehicle 10 reaches the first area.

Further, the control unit 31 of the center server 30 may inquire of the user whether or not to download the music data. When the user desires to download the music data, the control unit 31 of the center server 30 may send the music data to the vehicle 10 or may send a command to download the music data to the vehicle 10. The control unit 31 of the center server 30 may calculate, for example, a time at which music is interrupted, and send the time to the vehicle 10 so as to present the time to the user. Note that the time when music is interrupted may be the time when the vehicle 10 passes through the first area (that is, the passage time).

### OTHER EMBODIMENTS

The above-described embodiment is merely an example, and the present disclosure may be appropriately modified and implemented without departing from the scope thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

For example, in the above-described embodiment, the music data downloaded by the control unit 31 of the center server 30 is determined, but as another example, the music data downloaded by the control unit 11 of the vehicle 10 may be determined. In this case, the control unit 31 of the center server 30 may generate a quality map and provide it to the vehicle 10. Further, the music server 20 and the center server 30 may be the same server.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, magnetic disks (floppy disks, hard disk drives (HDD), etc.). Non-transitory computer-readable storage media include, for example, any type of disk, such as an optical disk (CD-ROM, DVD disk, Blu-ray disk, etc.), read only memory (ROM), random access memory (RAM). Non-transitory computer-readable storage media include, for example, EPROM, EEPROM, magnetic cards, flash memory, optical cards, any type of media suitable for storing electronic instructions.

What is claimed is:

1. An information processing device, comprising a control unit configured to
acquire a quality map regarding quality of wireless communication for each planned travel route and area of a first vehicle, and
when the planned travel route passes through a first area where the quality of the wireless communication is lower than predetermined quality, send data that the first vehicle uses in the first area to the first vehicle before the first vehicle reaches the first area.

2. The information processing device according to claim 1, wherein the first area is an area where a data transfer rate for downlink continues to be lower than required quality for a predetermined time or more.

3. The information processing device according to claim 1, wherein the control unit is further configured to
collect probe data regarding a data transfer rate for downlink from a plurality of second vehicles, and
generate the quality map regarding the downlink, based on the collected probe data.

4. The information processing device according to claim 3, wherein the probe data includes at least one of the following pieces of data that are periodically sent from wireless devices mounted on the second vehicles: Reference Signal Received Power, Reference Signal Received Quality, and Signal-to-Interference-plus-Noise Ratio.

5. The information processing device according to claim 1, wherein
the data that the first vehicle uses is music data, and
the control unit is configured to
acquire a time when the first vehicle enters the first area and a time when the first vehicle exits the first area,
acquire information on pieces of music to be played in the first vehicle,
estimate positions of the pieces of music corresponding to the time when the first vehicle enters the first area and the time when the first vehicle exits the first area, according to the information on the pieces of music to be played in the first vehicle, and
send the music data corresponding to the estimated positions of the pieces of music to the first vehicle before the first vehicle reaches the first area.
